(19) United States
(12) Patent Application Publication
(10) Pub. No.: US 2019/0218427 A1
(43) Pub. Date: Jul. 18, 2019

(54) ADHESIVE COMPOSITION, ADHESIVE LAYER, POLARIZING FILM COATED WITH ADHESIVE LAYER, LIQUID CRYSTAL PANEL, AND IMAGE DISPLAY DEVICE

(71) Applicant: NITTO DENKO CORPORATION, Ibaraki-shi, Osaka (JP)

(72) Inventors: Mizue Yamasaki, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/337,108

(22) PCT Filed: Sep. 27, 2017
(86) PCT No.: PCT/JP2017/034987

§ 371 Date: Mar. 27, 2019

(30) Foreign Application Priority Data
Sep. 30, 2016 (JP) 2016-194942

(51) Int. Cl. C09J 7/38; C09J 11/06; C09J 133/14; G02F 1/1335

(52) U.S. Cl. CPC C09J 7/385; C09J 11/06; C08K 5/29; G02F 1/133528; C09J 133/14

(57) ABSTRACT

Provided are: a highly durable pressure-sensitive adhesive layer which does not cause foaming or peeling even in a wet heat environment; and a pressure-sensitive adhesive composition which is capable of restraining an increase in the surface resistance of the pressure-sensitive adhesive layer and capable of forming a pressure-sensitive adhesive layer restraining corrosion of a transparent conductive layer. The pressure-sensitive adhesive composition includes a (meth)acrylic polymer; and an ionic compound having an anionic component and a cationic component, wherein the (meth)acrylic polymer includes 0.6% or more by weight of a nitrogen-containing monomer as a monomer unit, a total number of carbon atoms in the anionic component is 4 or more, and the anionic component is represented by at least one selected from (CₙF₂ₙ₊₁SO₂)₂N⁻ wherein n is an integer from 2 to 10, and CF₂(CₘF₂ₘSO₂)₂N⁻ wherein m is an integer from 2 to 10.

### TECHNICAL FIELD

The present invention relates to a pressure-sensitive adhesive composition; a pressure-sensitive adhesive layer made of the pressure-sensitive adhesive composition; and a pressure-sensitive adhesive layer attached optical film having the pressure-sensitive adhesive layer on at least one surface of a polarizing film. Furthermore, the invention relates to a liquid crystal panel having the pressure-sensitive adhesive layer attached polarizing film and a transparent-conductive-layer attached liquid crystal cell; and a liquid crystal display device, an organic EL display device and an image display device such as PDP which include the liquid crystal panel.

### BACKGROUND ART

Hitherto, in a liquid crystal panel used in an image display device, a polarizing film is laminated onto a liquid crystal cell with a transparent conductive layer to interpose therebetween a pressure-sensitive adhesive layer. Such a pressure-sensitive adhesive layer for an optical application, such as liquid crystal panels, is required to have a high transparency.

In image display devices, for example, for an electrode of a touch sensor, a transparent conductive layer is frequently used which is yielded by forming a metal oxide layer made of, for example, ITO (indium tin complex oxide) onto a transparent resin film.

For a pressure-sensitive adhesive composition used in image display devices, an acrylic pressure-sensitive adhesive is widely used, which contains a (meth)acrylic polymer. Known is, for example, a pressure-sensitive adhesive layer of a pressure-sensitive adhesive layer attached transparent conductive layer, the pressure-sensitive adhesive layer including an acrylic polymer containing, for monomer units thereof, an alkyl (meth)acrylate having an alkyl group having 2 to 14 carbon atoms (see, for example, Patent Document 1). Known is also, for example, a pressure-sensitive adhesive composition for optical films that includes a (meth)acrylic polymer yielded by polymerizing monomer components containing, as a main component, an alkyl (meth)acrylate having an alkyl group having 4 to 18 carbon atoms, and includes a phosphoric acid ester compound (see, for example, Patent Document 2).

### PRIOR ART DOCUMENTS

### Patent Documents

Patent Document 1: JP-A-2011-016908

Patent Document 2: JP-A-2015-028138

### SUMMARY OF THE INVENTION

### Problems to be Solved by the Invention

In such a situation, when a polarizing film and a transparent conductive layer are laminated onto each other through a pressure-sensitive adhesive layer to which antistatic function is given, the transparent conductive layer may be corroded from its end. The corrosion is remarkably caused, in particular, in a wet heat environment. Moreover, it has been newly understood that the transparent conductive layer is corroded by water contained in the pressure-sensitive adhesive layer that contacts the transparent conductive layer, and by a conductive agent for giving antistatic function to the pressure-sensitive adhesive layer. Furthermore, the corrosion of the transparent conductive layer also causes, for example, problems that in a contact interface between the pressure-sensitive adhesive layer and the transparent conductive layer, a peel thereof is caused, or the surface resistance is deteriorated.

About ITO and others as metal oxides used for the transparent conductive layer, a problem of corrosion by water or any conductive agent is hardly caused. Thus, it is conceived that a (single species) metal, alloy and others are used for a transparent conductive layer in which a problem of corrosion is easily generated by water or a conductive agent.

In this case, the following is conceived: the conductive agent added to give antistatic function to the pressure-sensitive adhesive layer heightens the water absorption coefficient of the pressure-sensitive adhesive layer, so that water contained in the pressure-sensitive adhesive layer advances the corrosion of the transparent conductive layer containing, for example, a metal mesh made of a (single species) metal or alloy. It is also conceived that the conductive agent is unevenly precipitated (or unevenly distributed) near the interface between the pressure-sensitive adhesive layer and the transparent conductive layer to accelerate the advance of the corrosion of the transparent conductive layer.

The pressure-sensitive adhesive layer described in Patent Document 1 is laid on a surface of a transparent plastic substrate which does not have thereon a transparent conductive layer. Thus, the pressure-sensitive adhesive layer contacts no transparent conductive layer. Consequently, no investigation is made about corrosion based on the pressure-sensitive adhesive layer. In Patent Document 2, an investigation is made about the corrosion of the transparent conductive layer. However, the invention therein is an invention of adding a phosphoric acid ester compound to a pressure-sensitive adhesive layer to restrain the corrosion. Thus, no description is made about any specified conductive agent.

Accordingly, an object of the present invention is to provide a pressure-sensitive adhesive layer satisfying durability that the pressure-sensitive adhesive layer is neither foamed nor peeled off even in a wet heat environment; a pressure-sensitive adhesive composition capable of forming a pressure-sensitive adhesive layer which can be restrained from being raised in surface resistance to restrain a rise in the surface resistance of a transparent conductive layer (in particular, a transparent conductive layer containing a metal mesh), which can gain a stable antistatic function, and which can further restrain the transparent conductive layer from being corroded; and a pressure-sensitive adhesive layer formed by using the pressure-sensitive adhesive composition.

Another object of the present invention is to provide a pressure-sensitive adhesive layer attached polarizing film having the pressure-sensitive adhesive layer; a liquid crystal panel using the pressure-sensitive adhesive layer attached polarizing film; and an image display device including the liquid crystal panel.

### Means for Solving the Problems

In order to solve the above-mentioned problems, the inventors have repeated eager investigations to find out a pressure-sensitive adhesive composition described below. Thus, the present invention has been accomplished.

Accordingly, the pressure-sensitive adhesive composition of the present invention includes a (meth)acrylic polymer, and an ionic compound having an anionic component and a cationic component; in which the (meth)acrylic polymer includes, 0.6% or more by weight of a nitrogen-containing monomer as a monomer unit; a total number of carbon atoms in the anionic component is 4 or more; and the anionic component is represented by at least one selected from the following general formula (1)

(CₙF₂ₙ₊₁SO₂)₂N⁻ (1)

wherein n is an integer from 2 to 10, and the following general formula (2):

CF₂(CₘF₂ₘSO₂)₂N⁻ (2)

wherein m is an integer from 2 to 10.

It is preferred that the pressure-sensitive adhesive composition of the present invention includes one or more crosslinking agents, and the crosslinking agent(s) include(s) an isocyanate crosslinking agent, and/or a peroxide crosslinking agent.

The pressure-sensitive adhesive layer of the present invention is preferably made of the pressure-sensitive adhesive composition.

The pressure-sensitive adhesive layer attached optical film of the present invention preferably includes a polarizing film having a polarizer and a transparent protective film formed on at least one surface of the polarizer; and the pressure-sensitive adhesive layer and formed on at least one surface of the polarizing film.

It is preferred that the liquid crystal panel of the present invention includes the pressure-sensitive adhesive layer attached polarizing film, and the polarizing film is bonded through the pressure-sensitive adhesive layer to a transparent conductive layer attached liquid crystal cell including a metal mesh.

The image display device of the present invention preferably includes the liquid crystal panel.

### Effect of the Invention

The pressure-sensitive adhesive composition of the present invention includes a (meth)acrylic polymer containing a specified monomer in a specified proportion, and an ionic compound having a specified anionic component and a specified cationic component. In this way, the following can be provided: a pressure-sensitive adhesive layer satisfying durability that the pressure-sensitive adhesive layer is neither foamed nor peeled off even in a wet heat environment; a pressure-sensitive adhesive composition capable of forming a pressure-sensitive adhesive layer which can be restrained from being raised in surface resistance to restrain a rise in the surface resistance of a transparent conductive layer (in particular, a transparent conductive layer containing a metal mesh), which can gain a stable antistatic function, and which restrains the corrosion of the transparent conductive layer; a pressure-sensitive adhesive layer formed using the pressure-sensitive adhesive composition; a pressure-sensitive adhesive layer attached polarizing film having the pressure-sensitive adhesive layer; a liquid crystal panel using the pressure-sensitive adhesive layer attached polarizing film; and an image display device including the liquid crystal panel.

### BRIEF DESCRIPTION OF THE DRAWINGS

FIG. 1 is a sectional view that schematically illustrates an embodiment of the pressure-sensitive adhesive layer attached polarizing film of the present invention.

FIG. 2 is a sectional view that schematically illustrates an embodiment of the image display device of the present invention.

FIG. 3 is a sectional view that schematically illustrates an embodiment of the image display device of the present invention.

FIG. 4 is a sectional view that schematically illustrates an embodiment of the image display device of the present invention.

### MODE FOR CARRYING OUT THE INVENTION

### 1. Pressure-Sensitive Adhesive Composition

The pressure-sensitive adhesive composition of the present invention includes a (meth)acrylic polymer, and an ionic compound having an anionic component and a cationic component.

### (1) (Meth)Acrylic Polymer

The pressure-sensitive adhesive composition includes a (meth)acrylic polymer. The use of the (meth)acrylic polymer produces a preferred embodiment excellent in transparency and heat resistance. The (meth)acrylic polymer usually contains, as a main component thereof, an alkyl (meth)acrylate for monomer units. The wording “(meth)acrylate” denotes acrylate and/or methacrylate. In the present invention, the expression “(meth)” has substantially the same meanings.

The alkyl (meth)acrylate, which constitutes a main skeleton of the (meth)acrylic polymer, is, for example, a (meth)acrylate having a linear or branched alkyl group having 1 to 18 carbon atoms. Examples of the alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These groups may be used singly or in combination.

The alkyl (meth)acrylate is a compound which is to be a main component in all monomers which constitute the (meth)acrylic polymer. The main component referred to herein denotes that in all the monomers, which constitute the (meth)acrylic polymer, the proportion of the alkyl (meth)acrylate is a proportion from 60 to 99.4% by weight, preferably from 60 to 99% by weight, more preferably from 65 to 90% by weight of all the monomers. By using the alkyl (meth)acrylate in a proportion in any one of the above-mentioned ranges, the pressure-sensitive adhesive composition favorably ensures adhesion property.

The (meth)acrylic polymer includes a nitrogen-containing monomer for monomer units. The nitrogen-containing monomer is a compound containing, in the structure thereof, a nitrogen atom and a polymerizable unsaturated double bond such as a (meth)acryloyl group or a vinyl group. The compound is usable without any limitation.

Examples of the nitrogen-containing monomer include maleimide, N-cyclohexylmaleimide, and N-phenylmaleimide; N-acryloylmorpholine; (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-butyl(meth)acrylamide, N-methylol(meth)acrylamide, N-methylolpropane(meth)acrylamide, and other (N-substituted) amide monomers; aminoethyl (meth)acrylate, aminopropyl (meth)acrylate, N,N-dimethylaminoethyl (meth)acrylate, t-butylaminoethyl (meth)acrylate, 3-(3-pyrinidyl)propyl (meth)acrylate, and other alkylaminoalkyl (meth)acrylate monomers; methoxyethyl (meth)acrylate, ethoxyethyl (meth)acrylate, and other alkoxyalkyl (meth)acrylate monomers; and N-(meth)acryloyloxymethylenesuccinimide, N-(meth)acryloyl-6-oxyhexamethylenesuccinimide, N-(meth)acryloyl-8-oxyoctamethylenesuccimide, N-acryloylmorpholine, and other succinimide monomers.

The nitrogen-containing monomer may be, for example, a cyclic nitrogen-containing monomer. As the cyclic nitrogen-containing monomer, the following is usable without any especial limitation: a monomer which has a polymerizable functional group having an unsaturated double bond, such as a (meth)acryloyl group or vinyl group, and further which has a cyclic nitrogen structure. The cyclic nitrogen structure is preferably a cyclic structure having therein a nitrogen atom. Examples of the cyclic nitrogen-containing monomer include N-vinylpyrrolidone, N-vinyl-ε-caprolactam, methylvinylpyrrolidone, and other lactam-based vinyl monomers; and vinylpyridine, vinylpiperidone, vinylpyrimidine, vinylpiperazine, vinylpyrazine, vinylpyrrole, vinylimidazole, vinyloxazole, vinylmorpholine, and other vinyl monomers each having a nitrogen-containing heterocycle. Other examples thereof include (meth)acrylic monomers each having a heterocycle such as a morpholine ring, piperidine ring, pyrrolidine ring, or piperazine ring. Specific examples thereof include N-acryloylmorpholine, N-acryloylpiperidine, N-methacryloylpiperidine, and N-acryloylpyrrolidine. It is preferred to add, in particular, a lactam-based vinyl monomer, such as N-vinylpyrrolidone, out of these nitrogen-containing monomers, to the composition, so as to produce a great effect of restraining the conductive agent from being unevenly precipitated in the pressure-sensitive adhesive layer to achieve good corrosion resistance.

In all the monomers constituting the (meth)acrylic polymer, the proportion of the nitrogen-containing monomer is 0.6% by weight or more, preferably from 0.01 to 30% by weight, more preferably from 0.03 to 25% by weight, even more preferably from 0.05 to 20% by weight of the monomers. In the present invention, the use of the nitrogen-containing monomer in a proportion in any one of these ranges favorably produces a corrosion restraining effect. If the proportion is less than 0.6% by weight, the conductive agent is unevenly distributed with ease so that the transparent conductive layer is unfavorably deteriorated in corrosion resistance.

In the present invention, it is preferred from the viewpoint of durability of the pressure-sensitive adhesive layer and the restraint of corrosion of the transparent conductive layer (in particular, the transparent conductive layer containing a metal mesh) that the (meth)acrylic polymer includes, for monomer units thereof, a carboxyl group-containing monomer and/or a hydroxyl group-containing monomer besides the alkyl (meth)acrylate and the nitrogen-containing monomer. From the viewpoint of the corrosion resistance of the transparent conductive layer, the nitrogen-containing monomer is preferred. It is next preferred that the (meth)acrylic polymer includes the hydroxyl group-containing monomer. It is next preferred that the polymer includes the carboxyl group-containing monomer.

The hydroxyl group-containing monomer is a compound containing, in the structure thereof, a hydroxyl group and a polymerizable unsaturated double bond, such as a (meth)acryloyl group or a vinyl group. Specific examples of the hydroxyl group-containing monomer include 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and other hydroxyalkyl (meth)acrylates; and (4-hydroxymethylcyclohexyl)-methyl acrylate. Out of these hydroxyl group-containing monomers, preferred are 2-hydroxyethyl (meth)acrylate, and 4-hydroxybutyl (meth)acrylate, and particularly preferred is 4-hydroxybutyl (meth)acrylate from the viewpoint of durability of the pressure-sensitive adhesive layer, an even dispersibility of the ionic compound (conductive agent) therein, and the corrosion restraining effect.

In all the monomers constituting the (meth)acrylic polymer, the proportion of the hydroxyl group-containing monomer is preferably from 0.01 to 10% by weight, more preferably from 0.03 to 5% by weight, even more preferably from 0.05 to 3% by weight of the monomers. When the proportion of the hydroxyl group-containing monomer is in any one of these ranges, the pressure-sensitive adhesive layer is sufficiently crosslinked so that the pressure-sensitive adhesive layer can favorably satisfy durability and can further gain therein an even dispersibility of the ionic compound (conductive agent), and a higher corrosion restraining effect.

As the carboxyl group-containing monomer, the following is usable without any limitation: a monomer which has a polymerizable functional group having an unsaturated double bond, such as a (meth)acryloyl group or vinyl group, and further which has a carboxyl group. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used singly or in any combination. About itaconic acid and maleic acid, respective anhydrides of these acids are usable. Out of these examples, acrylic acid and methacrylic acid are preferred, and acrylic acid is particularly preferred. In general, when a pressure-sensitive adhesive layer including a polymer containing, for monomer units thereof, a carboxyl group-containing monomer is used onto a metal-containing layer, for example, a transparent conductive layer containing a metal mesh made of a (single species) metal or alloy, the metal layer may be corroded due to the carboxyl group. Thus, usually, no carboxyl group-containing monomer is used for a pressure-sensitive adhesive for restraining corrosion. In the present invention, by incorporating the carboxyl group-containing monomer into the above-mentioned pressure-sensitive adhesive composition, the ionic compound (conductive agent) can be improved in dispersibility. In a pressure-sensitive adhesive layer made of the pressure-sensitive adhesive composition in which the ionic compound is improved in dispersibility, the ionic compound is not unevenly precipitated (or unevenly distributed), so that the layer can favorably gain an effect of restraining the corrosion of the transparent conductive layer containing the metal mesh.

In all the monomers constituting the (meth)acrylic polymer, the proportion of the carboxyl group-containing monomer is preferably 5% by weight or less, more preferably from 0.1 to 3% by weight, even more preferably from 0.1 to 1% by weight of the monomers. If the proportion of the carboxyl group-containing monomer is more than 5% by weight, the crosslinking of the pressure-sensitive adhesive is promoted so that the pressure-sensitive adhesive layer is remarkably made hard in pressure-sensitive adhesive property (or made high in storage modulus). Thus, the pressure-sensitive adhesive layer unfavorably undergoes inconveniences, such as peeling-off, in a durability test thereof. In the present invention, it is preferred that the carboxyl group-containing monomer is contained in a very small proportion of about 5% or less by weight since the pressure-sensitive adhesive layer can gain a corrosion restraining effect.

In the present invention, it is preferred from the viewpoint of durability and others that the (meth)acrylic polymer includes, for monomer units, an aromatic ring-containing (meth)acrylate besides the alkyl (meth)acrylate and the nitrogen-containing monomer. The aromatic ring-containing (meth)acrylate is a compound containing, in the structure thereof, an aromatic ring structure and a (meth)acryloyl group. Examples of the aromatic ring include benzene, naphthalene and biphenyl rings. The aromatic ring-containing (meth)acrylate can cause the pressure-sensitive adhesive layer to satisfy durability (particularly, durability against the transparent conductive layer containing the metal mesh), and can improve property against display unevenness based on white spots in the periphery of the display.

Specific examples of the aromatic ring-containing (meth)acrylate include benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethylene glycol (meth)acrylate, ethylene-oxide-modified nonylphenol (meth)acrylate, ethylene-oxide-modified cresol (meth)acrylate, phenol-ethylene-oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, polystyryl (meth)acrylate, and other (meth)acrylates each having a benzene ring; hydroxyethylated β-naphthol acrylate, 2-naphthoethyl (meth)acrylate, 2-naphthoxyethyl acrylate, 2-(4-methoxy-1-naphthoxy)ethyl (meth)acrylate, and other (meth)acrylates each having a naphthalene ring; and biphenyl (meth)acrylate, and other (meth)acrylates each having a biphenyl ring.

In all the monomers constituting the (meth)acrylic polymer, the proportion of the aromatic ring-containing (meth)acrylate is from 3 to 25% by weight, preferably from 8 to 22% by weight, even more preferably from 12 to 18% by weight of the monomers. When the proportion of the aromatic ring-containing (meth)acrylate is in any one of these ranges, the aromatic ring-containing (meth)acrylate can cause the pressure-sensitive adhesive layer to satisfy durability (particularly, durability against the transparent conductive layer containing the metal mesh), and can improve property against display unevenness based on white spots in the periphery of the display.

Besides the alkyl (meth)acrylate, the nitrogen-containing monomer, the carboxyl group-containing monomer, the hydroxyl group-containing monomer, and the aromatic ring-containing (meth)acrylate, a copolymerizable monomer other than these monomers may be incorporated into the (meth)acrylic polymer as far as the advantageous effects of the present invention are not damaged. In all the monomers constituting the (meth)acrylic polymer, the blend proportion thereof is preferably about 10% or less by weight of the monomers.

The (meth)acrylic polymer in the present invention is usually a (meth)acrylic polymer having a weight average molecular weight (Mw) ranging from 500,000 to 3,000,000. Considering durability, particularly, the heat resistance of the resultant pressure-sensitive adhesive layer, the weight average molecular weight is preferably from 700,000 to 2,700,000. The molecular weight is more preferably from 800,000 to 2,500,000. If the weight average molecular weight is less than 500,000, the crosslinking agent amount needs to be increased so that the flexibility of the crosslinkage is lost. Thus, the pressure-sensitive adhesive layer cannot relieve stress based on the shrinkage of the polarizing film to be unfavorably peeled off in durability. If the weight average molecular weight is more than 3,000,000, a large volume of a diluting solvent unfavorably becomes necessary to adjust the pressure-sensitive adhesive composition into a viscosity for being applied, so that costs are increased. The weight average molecular weight is determined by GPC (gel permeation chromatography) and calculated from polystyrene conversion.

For the production of the (meth)acrylic polymer, a known producing method is appropriately selectable, examples thereof including solution polymerization, bulk polymerization, emulsion polymerization, and various radical polymerizations. The obtained (meth)acrylic polymer may be any one of a random copolymer, a block copolymer, a graft copolymer, and others.

In the solution polymerization, as a polymerizing solvent, for example, ethyl acetate or toluene is used. In a specific example of the solution polymerization, a reaction therefor is conducted in the presence of an added polymerization initiator under the flow of an inert gas, such as nitrogen, ordinarily under conditions of a temperature of about 50 to 70° C. and a period of about 5 to 30 hours.

The polymerization initiator, and a chain transfer agent, an emulsifier and others that are used in each of the radical polymerizations are not particularly limited, and are appropriately selectable to be used. The weight average molecular weight of the (meth)acrylic polymer is controllable by the respective use amounts of the polymerization initiator and the chain transfer agent, and the reaction conditions. The use amounts are appropriately adjusted in accordance with the species of these agents.

Examples of the polymerization initiator include 2,2′-azobisisobutyronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine) disulfate, 2,2′-azobis(N,N′-dimethyleneisobutylamidine), 2,2′-azobis[N-(2-carboxyethyl)-2-methylpropionamidine] hydrate (trade name: VA-057, manufactured by Wako Pure Chemical Industries, Ltd.), and other azo initiators; potassium persulfate, ammonium persulfate, and other persulfates; di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, hydrogen peroxide, and other peroxide initiators; and any combination of a persulfate with sodium hydrogensulfite; and redox initiators in each of which a peroxide is combined with a reducing agent, such as a combination of a peroxide with sodium ascorbate. However, the polymerization initiator is not limited to these examples.

Such polymerization initiators may be used singly or in the form of a mixture of two or more thereof. The content of the whole of the polymerization initiator(s) is preferably from about 0.005 to 1 part by weight, more preferably from about 0.02 to 0.5 parts by weight for 100 parts by weight of all the monomers constituting the (meth)acrylic polymer.

In order to use, as the polymerization initiator, for example, 2,2′-azobisisobutyronitrile to produce a (meth)acrylic polymer having a weight average molecular weight in any one of the above-mentioned ranges, the use amount of the polymerization initiator is preferably from about 0.06 to 0.2 parts by weight, more preferably from about 0.08 to 0.175 parts by weight for 100 parts by weight of all the monomers constituting the (meth)acrylic polymer.

In the case of using the chain transfer agent, and the emulsifier or reactive emulsifier used in the emulsion polymerization, these may be appropriate agents known in the prior art. The respective addition amounts of these agents may be appropriately decided as far as the advantageous effects of the present invention are not damaged.

### (2) Ionic Compound (Conductive Agent)

The pressure-sensitive adhesive composition includes an ionic compound (conductive agent) having an anionic component and a cationic component, and the total number of carbon atoms in the anionic component is 4 or more. The anionic component is represented by at least one selected from the following general formula (1)

(CₙF₂ₙ₊₁SO₂)₂N⁻ (1)

wherein n is an integer from 2 to 10, and the following general formula (2):

CF₂(CₘF₂ₘSO₂)₂N⁻ (2)

wherein m is an integer from 2 to 10. By using the ionic compound, the pressure-sensitive adhesive layer can ensure antistatic function. It is feared that the incorporation of any ionic compound into the pressure-sensitive adhesive layer may cause a corrosion of a transparent conductive layer (particularly, a transparent conductive layer containing a metal mesh) which contacts the pressure-sensitive adhesive layer. In particular, in a wet heat environment, the ionic compound in the pressure-sensitive adhesive layer is unevenly precipitated (or unevenly distributed) on a side of the pressure-sensitive adhesive layer that contacts the transparent conductive layer containing the metal mesh, so that the transparent conductive layer may be corroded. Thus, in the anionic component included in the ionic compound, the total number of its carbon atoms is 4 or more, preferably 5 or more, more preferably 6 or more, even more preferably 7 or more. The upper limit value of the total carbon atom number in the anionic component is not particularly limited, and is preferably 16 or less, more preferably 10 or less. The use of the anionic component, the total carbon atom number of which is 4 or more and the molecular weight of which is high, makes the molecular weight (molar molecular weight) of the ionic compound large to lower the water absorption coefficient of the pressure-sensitive adhesive layer containing the ionic compound, and further not to cause, with ease, an uneven precipitation (uneven distribution) of the ionic compound in an interface at which the pressure-sensitive adhesive layer contacts the transparent conductive layer. Consequently, the ionic compound easily keeps a state of being evenly dispersed. This matter can result in a restraint of the corrosion of transparent conductive layer (in particular, the transparent conductive layer containing the metal mesh) and further a restraint of a rise of the pressure-sensitive adhesive layer surface in surface resistance to restrain a rise of the transparent conductive layer in surface resistance, and other inconveniences.

If the anionic component included in the ionic compound (conductive agent) has a total carbon atom number less than 4, the following would be caused: the pressure-sensitive adhesive layer becomes high in water absorption coefficient to advance the corrosion of the transparent conductive layer containing the metal mesh, which is made of a (single species) metal or alloy. The following would also be caused: as the molecular weight of the ionic compound becomes smaller, the ionic compound in the pressure-sensitive adhesive layer is more easily shifted into the vicinity of the interface between the pressure-sensitive adhesive layer and the transparent conductive layer containing the metal mesh, so that the ionic compound is unevenly precipitated (or unevenly distributed) to cause a corrosion of the conducive layer by the ionic compound neat the interface. Furthermore, the following would be caused: in the pressure-sensitive adhesive layer, the low molecular weight ionic compound tends to be unevenly precipitated (or unevenly distributed) in a large quantity near the interface between the pressure-sensitive adhesive layer and the transparent conductive layer containing the metal mesh, so that the advance of the corrosion is accelerated by the ionic compound near the interface. These phenomena are remarkably caused in the transparent conductive layer containing the metal mesh, and are more remarkably caused, particularly, in a wet heat environment.

The following will describe the anionic component and the cationic component included in the ionic compound.

### <Anionic Component of Ionic Compound>

In the present invention, the anionic component included in the ionic compound is preferably a component in which the total number of carbon atoms is 4 or more. In this case, the ionic compound itself is made high in hydrophobicity, and thus the pressure-sensitive adhesive layer does not easily contain water therein so that the corrosion of the transparent conductive layer (in particular, the transparent conductive layer containing the metal mesh) can be restrained.

From the viewpoint of the restraint of the corrosion, the anionic component is preferably an anionic component represented by at least one selected from the following general formula (1)

(CₙF₂ₙ₊₁SO₂)₂N⁻ (1)

wherein n is an integer from 2 to 10, and the following general formula (2):

CF₂(CₘF₂ₘSO₂)₂N⁻ (2)

wherein m is an integer from 2 to 10 (m is preferably an integer from 3 to 10).

Specific examples of the anionic component represented by the general formula (1) include a bis(nonafluorobutanesulfonyl)imide anion, a bis(undecafluoropentanesulfonyl)imide anion, a bis(tridecafluorohexanesulfonyl)imide anion, and a bis(pentadecafluoroheptanesulfonyl)imide anion. Out of these examples, preferred is a bis(nonafluorobutanesulfonyl)imide anion.

An example of the anionic component represented by the general formula (2) is an N,N-decafluoropentane-1,5-disulfonylimide anion.

### (Cationic Component of Ionic Compound)

In the present invention, the cationic component is preferably an organic cation. The carbon atom number of the cation is preferably 6 or more, more preferably 8 or more, even more preferably 10 or more. The upper limit value of the carbon atom number of the cation is not particularly limited, and is preferably 40 or less, more preferably 30 or less. When the carbon atom number of the cation is 6 or more, the ionic compound itself is made high in hydrophobicity, and thus the pressure-sensitive adhesive layer does not easily contain water therein so that the corrosion of the transparent conductive layer (in particular, the transparent conductive layer containing the metal mesh) can be favorably restrained.

The cationic component preferably has an organic group. The organic group is preferably an organic group having 3 or more carbon atoms, more preferably an organic group having 7 or more carbon atoms.

When the cationic component of the ionic compound is an organic cation, the cationic component is combined with the anionic component to constitute an organic cation-anion salt as the ionic compound. The organic cation-anion salt is also called an ionic liquid or ionic solid. Specific examples of the organic cation include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, and a tetraalkylphosphonium cation.

Specific examples of the organic cation-anion salt may be salts selected appropriately from compounds each made of a combination of any one of the cationic components with any one of the anionic components; and include butylmethylimidazolium bis(nonafluorobutanesulfonyl)imide, N-butyl-methypyridinium bis(nonafluorobutanesulfonyl)imide, methylpropylpyrrolidinium bis(nonafluorobutanesulfonyl)imide, 1-butyl-3-methypyridinium bis(heptafluoropropanesulfonyl)imide, 1-butyl-3-methylpyridinium bis(nonafluorobutanesulfonyl)imide, 1-ethyl-3-methylimidazolium bis(heptafluoropropanesulfonyl)imide, 1-ethyl-3-methylimidazolium bis(nonafluorobutanesulfonyl)imide, and methyltrioctylammonium bis(nonafluorobutanesulfonyl)imide.

Specific examples of the alkali metal salt include lithium bis(heptafluoropropanesulfonyl)imide, sodium bis(heptafluoropropanesulfonyl)imide, potassium bis(heptafluoropropanesulfonyl)imide, lithium bis(nonafluorobutanesulfonyl)imide, sodium bis(nonafluorobutanesulfonyl)imide, and potassium bis(nonafluorobutanesulfonyl)imide.

The use amount of the ionic compound in the pressure-sensitive adhesive composition of the present invention is preferably from 0.001 to 10 parts by weight, more preferably from 0.1 to 5 parts by weight, even more preferably from 0.3 to 3 parts by weight for 100 parts by weight of the (meth)acrylic polymer. If the amount of the ionic compound is less than 0.001 parts by weight, the effect of lowering the surface resistance value may become poor. In the meantime, if the amount of the ionic compound is more than 10 parts by weight, the transparent conductive layer may be deteriorated in corrosion resistance and durability.

### (3) Crosslinking Agent

The pressure-sensitive adhesive composition of the present invention may include a crosslinking agent. The use of the crosslinking agent is preferred since the use gives cohesive strength related to durability of the pressure-sensitive adhesive layer to the pressure-sensitive adhesive layer. The crosslinking agent may be an organic-based crosslinking agent or a polyfunctional metal chelate. Examples of the organic-based crosslinking agent include isocyanate-based crosslinking agents, peroxide-based crosslinking agents, epoxy-based crosslinking agents, and imine-based crosslinking agents. The polyfunctional metal chelate is a substance in which a polyvalent metal is bonded to an organic compound through covalent bonding or coordinate bonding. Examples of the polyvalent metal include Al, Cr, Zr, Co, Cu, Fe, Ni, V, Zn, In, Ca, Mg, Mn, Y, Ce, Sr, Ba, Mo, La, Sn, and Ti. The covalent-bonded or coordination-bonded atom in the organic compound is, for example, an oxide atom. Examples of the organic compound include alkyl esters, alcohol compounds, carboxylic acid compounds, ether compounds, and ketone compounds.

The pressure-sensitive adhesive composition of the present invention in particular preferably contains, as the crosslinking agent, an isocyanate-based crosslinking agent, and/or a peroxide-based crosslinking agent.

The isocyanate-based crosslinking agent may be a compound having at least two isocyanate groups. For example, a known isocyanate used generally in urethanization reaction is used, examples thereof including aliphatic polyisocyanates, alicyclic polyisocyanates, and aromatic polyisocyanates.

Examples of the aliphatic polyisocyanates include trimethylenediisocyanate, tetramethylenediisocyanate, haxamethylenediisocyanate, pentamethylenediisocyanate, 1,2-propylenediisocyanate, 1,3-butylenediisocyanate, dodecamethylenediisocyanate, and 2,4,4-trimethylhexamethylenediisocyanate.

Examples of the alicyclic polyisocyanates include 1,3-cyclopentenediisocyanate 1,3-cyclohexanediisocyanate, 1,4-cyclohexanediisocyanate, isophoronediisocyanate, hydrogenated diphenylmethanediisocyanate, hydrogenated xylylenediisocyanate, hydrogenated tolylenediisocyanate, and hydrogenated tetramethylxylylenediisocyanate.

Examples of the aromatic polyisocyanates include phenyenediisocyanate, 2,4-tolylenediisocyanate, 2,6-tolylenediisocyanate, 2,2′-diphenylmethanediisocyanate, 4,4′-diphenylmethanediisocyanate, 4,4′-toluidinediisocyanate, 4,4′-diphenyl ether diisocyanate, 4,4′-diphenyldiisocyanate, 1,5-naphthalenediisocyanate, and xylylene diisocyanate.

Other examples of the isocyanate-based crosslinking agent include multi-mers (dimer, trimer, pentamer and others) of the above-mentioned diisocyanates; and urethane modified products, urea modified products, biuret modified products, alphanate modified products, isocyanurate modified products and carbodiimide modified products thereof, which have been caused to react with a polyhydric alcohol such as trimethylolpropane.

Examples of a commercially available product of the isocyanate-based crosslinking agent include respective products with trade names “MILLIONATE MT”, “MILLIONATE MTL”, “MILLIONATE MR-200”, “MILLIONATE MR-400”, “CORONATE L”, “CORONATE HL”, and “CORONATE HX”, each manufactured by Nippon Polyurethane Industry Co., Ltd.; and respective products with trade names “TAKENATE D-110N”, “TAKENATE D-120N”, “TAKENATE D-140N”, “TAKENATE D-160N”, “TAKENATE D-165N”, “TAKENATE D-170HN”, “TAKENATE D-178N”, “TAKENATE 500”, and “TAKENATE 600”, each manufactured by Mitsui Chemicals, Inc. These compounds may be used singly, or in the form of a mixture of two or more thereof.

The isocyanate-based crosslinking agent is preferably an aliphatic polyisocyanate-based compound that includes an aliphatic polyisocyanate and a modified product of the aliphatic polyisocyanate. The aliphatic polyisocyanate-based compound is richer in crosslinked-structure flexibility than other isocyanate-based crosslinking agents, so that the resultant pressure-sensitive adhesive layer easily relieves stress which follows expansion/shrinkage of the optical film. Thus, the optical film does not easily undergo peeling-off in a durability test. The aliphatic polyisocyanate-based compound is in particular preferably hexamethylenediisocyanate and a modified product thereof.

As the peroxide-based crosslinking agent, an appropriately selected peroxide is usable as far as the peroxide is a peroxide which is heated or irradiated with light to generate a radical active species to advance the crosslinkage of the base polymer of the pressure-sensitive adhesive composition. Considering the workability and stability of the peroxide, it is preferred to use a peroxide about which the one-minute half-life temperature is from 80 to 160° C. More preferably, a peroxide about which the temperature is from 90 to 140° C. is used.

Usable examples of the peroxide include di(2-ethylhexyl) peroxydicarbonate (one-minute half-life temperature: 90.6° C.), di(4-t-butylcyclohexyl) peroxydicarbonate (1 minute half-life temperature: 92.1° C.), di-sec-butyl peroxydicarbonate (one-minute half-life temperature: 92.4° C.), t-butyl peroxyneodecanoate (one-minute half-life temperature: 103.5° C.), t-hexyl peroxypivalate (one-minute half-life temperature: 109.1° C.), t-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), t-butyl peroxyisobutyrate (one minute half-life temperature: 136.1° C.), and 1,1-di(t-hexylperoxy)cyclohexane (one-minute half-life temperature: 149.2° C.). Out of these examples, particularly preferred are, for example, di(4-t-butylcyclohexyl) peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) since these compounds are excellent in crosslinking reaction efficiency.

The half-life of each of the peroxides is an index representing the decomposition rate of the peroxide, and denotes a period until the remaining amount of the peroxide is reduced by half. The decomposition temperature of the peroxide at which the half-life is gained in any period, and the half-life period at any temperature are described in, for example, maker's catalogue, and are described in, for example, “Organic Peroxide Catalogue 9th Edition, May 2003” furnished by NOF CORPORATION.

The amount of decomposition of the peroxide may be determined by measuring the peroxide residue after the reaction process by, for example, HPLC (high performance liquid chromatography).

More specifically, for example, each weight of about 0.2 g is taken out from the pressure-sensitive adhesive composition after the reaction treatment. The taken-out sample is immersed in 10 mL of ethyl acetate. The immersed sample is shaken in a shaker at 25° C. and 120 rpm for 3 hours to extract the peroxide. Thereafter, the extracted peroxide is allowed to stand still at room temperature for 3 days. Next, thereto is added 10 mL of acetonitrile, and the resultant is shaken at 25° C. and 120 rpm for 30 minutes. The resultant is filtrated through a membrane filter (0.45 μm), and then about 10 μL of the resultant extract is poured into HPLC to make an analysis. In this way, the amount of the peroxide after the reaction treatment can be gained.

The use amount of the crosslinking agent is preferably from 0.01 to 3 parts by weight, more preferably from 0.02 to 2 parts by weight, even more preferably from 0.03 to 1 part by weight for 100 parts by weight of the (meth)acrylic polymer. If the amount of the crosslinking agent is less than 0.01 parts by weight, the crosslinkage of the pressure-sensitive adhesive layer is insufficient so that the layer may not unfavorably satisfy durability or adhesive properties. If the amount is more than 3 parts by weight, the pressure-sensitive adhesive layer tends to be excessively hard to be lowered in durability.

### (4) Silane Coupling Agent

The pressure-sensitive adhesive composition of the present invention may include a silane coupling agent. The use of the silane coupling agent can improve durability of the pressure-sensitive adhesive layer. Specific examples of the silane coupling agent include 3-glycidoxypropyltrimethoxysilane, 3-glycidoxypropyltriethoxysilane, 3-glycidoxypropylmethyldiethoxysilane, 2-(3,4-epoxycyclohexyl)ethyltrimethoxysilane, and other epoxy group-containing silane coupling agents; 3-aminopropyltrimethoxysilane, N-2-(aminoethyl)-3-aminopropylmethyldimethoxysilane, 3-triethoxysilyl-N-(1,3-dimethylbutylidene)propylamine, N-phenyl-γ-aminopropyltrimethoxysilane, and other amino group-containing silane coupling agents; 3-acryloxypropyltrimethoxysilane, 3-methacryloxypropyltriethoxysilane, and other (meth)acryl group-containing silane coupling agents; and 3-isocyanatopropyltriethoxysilane, and other isocyanate group-containing silane coupling agents. Out of the silane coupling agents given as the examples, epoxy group-containing silane coupling agents are preferred.

The silane coupling agent may be a silane coupling agent having a molecule having therein plural alkoxysilyl groups. Specific examples thereof include products X-41-1053, X-41-1059A, X-41-1056, X-41-1805, X-41-1818, X-41-1810, and X-40-2651 manufactured by Shin-Etsu Chemical Co., Ltd. These silane coupling agents, which each have in the molecule thereof plural alkoxysilyl groups, are favorable since the agents do not vaporize easily, and are effective for improving the pressure-sensitive adhesive layer in durability because of the plural alkoxysilyl groups which the agents each have. The durability is favorable, particularly, also when an adherend of the pressure-sensitive adhesive layer attached optical film is a transparent conductive layer which is less reactive with the alkoxysilyl groups than glass. The silane coupling agent having a molecule having therein plural alkoxysilyl groups is preferably a silane coupling agent having in the molecule thereof an epoxy group. The silane coupling agent is more preferably an agent having in the molecule thereof plural epoxy groups. The silane coupling agent having in the molecule thereof plural alkoxysilyl groups and one or more epoxy groups tends to be good in durability also when the adherend is a transparent conductive layer. Specific examples of the silane coupling agent, which has in the molecule thereof plural alkoxysilyl groups and one or more epoxy groups, include products X-41-1053, X-41-1059A, and X-41-1056 manufactured by Shin-Etsu Chemical Co., Ltd. Particularly preferred is the product X-41-1056 manufactured by Shin-Etsu Chemical Co., Ltd., in which the proportion of the contained epoxy groups is large.

These silane coupling agents may be used singly or in the form of a mixture of two or more thereof. The content of the whole of the agent(s) is preferably from 0.001 to 5 parts by weight, more preferably from 0.01 to 1 part by weight, even more preferably from 0.02 to 1 part by weight, even more preferably from 0.05 to 0.6 parts by weight for 100 parts by weight of the (meth)acrylic polymer. Such an amount is an amount permitting the pressure-sensitive adhesive layer to be improved in durability and to keep adhering strength to glass and the transparent conductive layer.

### (4) Others

The pressure-sensitive adhesive composition of the present invention may further contain other known additives. For example, the following may be appropriately added to the composition in accordance with the usage thereof: a polyether compound of a polyalkylene glycol, such as polypropylene glycol, a colorant, a powder such as pigment, a dye, a surfactant, a plasticizer, a tackifier, a surface lubricant, a levelling agent, a softener, an antioxidant, an antiaging agent, a light stabilizer, an ultraviolet absorbent, a polymerization inhibitor, an inorganic or organic filler, a metallic powder, or a particulate- or foil-form material.

### 2. Pressure-Sensitive Adhesive Layer

The pressure-sensitive adhesive layer of the present invention is made of the pressure-sensitive adhesive composition.

The method for forming the pressure-sensitive adhesive layer is, for example, a method of applying the pressure-sensitive adhesive composition onto, for example, a separator subjected to releasing treatment, and drying/removing a polymerization solvent and others therein to form the pressure-sensitive adhesive layer. The pressure-sensitive adhesive layer may also be produced by, for example, a method of applying the pressure-sensitive adhesive composition onto a polarizing film that will be detailed later, and drying/removing a polymerization solvent and others therein to form the pressure-sensitive adhesive layer on the polarizing film. In the application of the pressure-sensitive adhesive composition, one or more solvents other than the polymerizing solvent may be newly added appropriately to the composition.

The separator subjected to releasing treatment is preferably a silicone release liner. When the pressure-sensitive adhesive composition of the present invention is applied onto such a liner and then dried to form the pressure-sensitive adhesive layer, the method for drying the pressure-sensitive adhesive may be a suitable method selected appropriately in accordance with a purpose. Preferably, the method is the above-mentioned applied-film heating and drying method. The temperature for the heating and the drying is preferably from 40° C. to 200° C., more preferably from 50° C. to 180° C., in particular preferably from 70° C. to 170° C. When the heating temperature is set in any one of these ranges, a pressure-sensitive adhesive can be yielded which has very good adhesive properties.

About the drying period, a suitable period is appropriately adoptable. The drying period is preferably from 5 seconds to 20 minutes, more preferably from 5 seconds to 10 minutes, in particular preferably from 10 seconds to 5 minutes.

The method for applying the pressure-sensitive adhesive composition may be any one of various methods. Specific examples thereof include roll coating, kiss roll coating, gravure coating, reverse coating, roll brushing, spray coating, dip roll coating, bar coating, knife coating, air knife coating, curtain coating, lip coating, and extrusion coating using, for example, a die coater.

The thickness of the pressure-sensitive adhesive layer (after the drying thereof) is not particularly limited, and is, for example, from about 1 to 100 μm, and is preferably from 2 to 50 μm, more preferably from 2 to 40 μm, even more preferably from 5 to 35 μm. If the thickness of the pressure-sensitive adhesive layer is less than 1 μm, the layer becomes poor in adhesiveness to an adherend (for example, a polarizing film or a transparent conductive layer) to tend to be insufficient in durability in a wet heat environment. In the meantime, if the thickness of the pressure-sensitive adhesive layer is more than 100 μm, the pressure-sensitive adhesive composition is not sufficiently dried when the pressure-sensitive adhesive composition is applied and dried in the formation of the pressure-sensitive adhesive layer, so that foams remain and thickness unevenness is generated in the pressure-sensitive adhesive layer. Thus, external appearance problems of the pressure-sensitive adhesive layer tend to become apparent easily.

### 3. Pressure-Sensitive Adhesive Layer Attached Polarizing Film

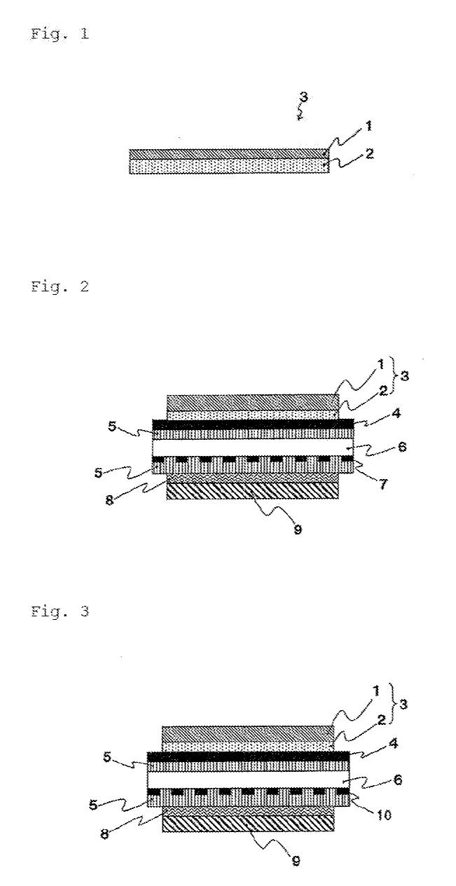

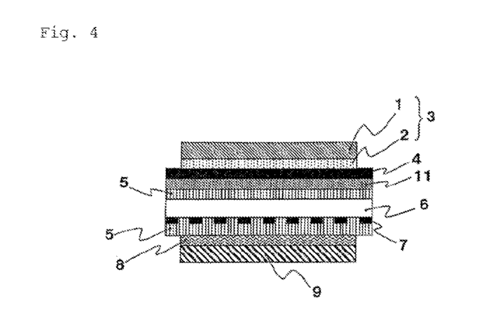

The pressure-sensitive adhesive layer attached polarizing film used in the present invention preferably has a pressure-sensitive adhesive layer attached polarizing film having a polarizing film having a polarizer and a transparent protective film on at least one surface of the polarizer, and the pressure-sensitive adhesive layer (made of the pressure-sensitive adhesive composition) on at least one surface of the polarizing film. As illustrated in, for example, FIG. 1, a pressure-sensitive adhesive layer attached polarizing film 3 used in the present invention is a film in which a polarizing film 1 and a pressure-sensitive adhesive layer 2 are laminated onto each other. Moreover, as illustrated in each of FIGS. 2 to 4, a pressure-sensitive adhesive layer attached polarizing film 3 used in the present invention is used in the state of being bonded to a transparent conductive layer 4 of a transparent conductive layer attached liquid crystal cell (glass substrate 5+liquid crystal layer 6+glass substrate 5).

The method for forming the pressure-sensitive adhesive layer is as described above.

In a case where about the pressure-sensitive adhesive layer attached polarizing film used in the present invention its pressure-sensitive adhesive layer is formed on a separator subjected to releasing treatment, the pressure-sensitive adhesive layer attached polarizing film can be formed by transferring the pressure-sensitive adhesive layer on the separator onto a transparent protective film surface of a polarizing film. The pressure-sensitive adhesive layer attached polarizing film can be also formed by applying the pressure-sensitive adhesive composition directly onto a polarizing film and drying/removing a polymerization solvent and others therein.

The pressure-sensitive adhesive layer may be formed after an anchor layer is formed onto the surface of the polarizing film on which the pressure-sensitive adhesive composition is to be applied, or after the surface is subjected to corona treatment, plasma treatment, or any other easily-bonding treatment that may be of various types. An easily-bonding treatment may be applied onto the surface of the pressure-sensitive adhesive layer.

When the pressure-sensitive adhesive layer is exposed in the pressure-sensitive adhesive layer attached polarizing film, the pressure-sensitive adhesive layer may be protected with a sheet subjected to releasing treatment (separator) until the pressure-sensitive adhesive layer attached polarizing film is bonded to a transparent conductive layer.

Examples of the material for forming the separator include plastic films such as polyethylene, polypropylene, polyethylene terephthalate, and polyester film; porous material such as paper, cloth and nonwoven fabric; and appropriate thin sheets such as net, foamed sheet, metal foil, and laminate thereof. In particular, plastic film is preferably used, because of its good surface smoothness.

The plastic films are not particularly limited as long as the films are each a film capable of protecting the pressure-sensitive adhesive layer. Examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is usually from about 5 to 200 μm, preferably from about 5 to 100 μm. As required, the separator may be subjected to a releasing and antifouling treatment with, for example, a silicone-based, fluorine-based, long-chain alkyl-based or aliphatic acid amide-based releasing agent, or silica powder, or to an antistatic treatment of, for example, a coating type, kneading and mixing type, or vapor-deposition type. The peelability of the separator from the pressure-sensitive adhesive layer can be made higher, particularly, by subjecting the surface of the separator appropriately to a releasing treatment, such as silicone treatment, long-chain alkyl treatment or fluorine treatment.

The sheet subjected to releasing treatment, which is used to produce the pressure-sensitive adhesive layer attached polarizing film, is usable, as it is, as a separator for the pressure-sensitive adhesive layer attached polarizing film. Thus, the production of the film can be simplified from the viewpoint of a process therefor.

As the polarizing film, a polarizing film is used which has a polarizer and a transparent protective film formed on at least one surface of the polarizer.

The polarizer is not particularly limited, and may be a polarizer that may be of various types. Examples of the polarizer include a product yielded by causing a dichronic substance, such as iodine or a dichronic dye, to be adsorbed onto a hydrophilic polymer film, such as a polyvinyl alcohol-based film, a partially formylated polyvinyl alcohol-based film or an ethylene/vinyl acetate copolymer based-partially-saponified film, and then stretching the resultant uniaxially; and a polyene-based aligned film made of, for example, a polyvinyl-alcohol-dehydrated product or a polyvinyl-chloride dehydrochloride-treated product. Out of these examples, preferred is a polarizer made of a polyvinyl alcohol film, and a dichronic substance such as iodine. More preferred is an iodine-based polarizer containing iodine and/or an iodine ion. The thickness of each of these polarizers is not particularly limited, but is generally from about 5 to 80 μm.

The polarizer in which a polyvinyl alcohol-based film dyed with iodine has uniaxially stretched can be produced, for example, by immersing a polyvinyl alcohol into an aqueous solution of iodine to be dyed, and then stretching the resultant film into a length 3 to 7 times the original length of this film. As required, the stretched film may be immersed into an aqueous solution of, for example, potassium iodide which may contain, for example, boric acid, zinc sulfite or zinc chloride. Furthermore, before the dyeing, the polyvinyl alcohol-based film may be immersed into water as required to be cleaned with water. The cleaning of the polyvinyl alcohol-based film with water can clean stains and a blocking-preventing agent on surfaces of the polyvinyl alcohol-based film, and further produce an advantageous effect of swelling the polyvinyl alcohol-based film to prevent unevenness of the dyeing and any other unevenness. The stretching may be performed after the dyeing with iodine or while the dyeing is performed. Alternatively, after the stretching, the dyeing with iodine may be performed. The stretching may be performed in an aqueous solution of, for example, boric acid or potassium iodide, or in a water bath.

In the present invention, a thin polarizer having a thickness of 10 μm or less may be used. From the viewpoint of making the polarizing film thinner, the thickness is preferably from 1 to 7 μm. Such a thin polarizer is favorable in that the polarizer is small in thickness unevenness, excellent in viewability and is small in dimension change to be excellent in durability; and further makes the resultant polarizing film also thin.

Typical examples of the thin polarizer include thin polarizing membranes described in JP-A-S51-069644, JP-A-2000-338329, the pamphlet of WO 2010/100917, the pamphlet of WO 2010/100917, the specification of Japanese Patent No. 4751481, and JP-A-2012-073563. These thin polarizing membranes can each be yielded by a producing method including the step of stretching a polyvinyl alcohol-based resin (hereinafter referred to also as a PVA-based resin) layer and a resin substrate for stretching in a laminate state, and the step of dyeing the laminate. On the basis of the supporting of the PVA-based resin layer on the resin substrate for stretching, this producing method allows to stretch the laminate without causing inconveniences, such as breaking by the stretching, even when the PVA-based resin layer is thin.

The thin polarizing membranes are preferably polarizing membranes each yielded by the following producing method, out of producing methods including the step of stretching the members concerned in a laminate state thereof and the step of dyeing the laminate, since the laminate can be stretched into a high stretch ratio to improve the resultant in polarizing performance: a producing method including the step of stretching the laminate in an aqueous solution of boric acid, as is described in the pamphlet of WO 2010/100917, the pamphlet of WO 2010/100917, the specification of Japanese Patent No. 4751481, and JP-A-2012-073563. The membranes are in particular preferably membranes each yielded by a producing method including the step of stretching the laminate supplementally in the air before the stretching in the aqueous solution of boric acid, as is described in the specification of Japanese Patent No. 4751481, and JP-A-2012-073563.

The material for constituting the transparent protective film is, for example, a thermoplastic resin excellent in transparency, mechanical strength, thermal stability, water blocking performance, isotropy, and others. Specific examples of the thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin resins (norbornene resins), polyarylate resins, polystyrene resins, and polyvinyl alcohol resins; and mixtures of two or more of these resins. The transparent protective film may contain one or more appropriate additives selected at will. Examples of the additives include an ultraviolet absorbent, an antioxidant, a lubricant, a plasticizer, a releasing agent, an anti-coloring agent, a flame retardant, a nucleating agent, an antistatic agent, a pigment and a colorant. The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is 50% or less by weight, it is feared that a high transparency and others that the thermoplastic resin originally has cannot be sufficiently expressed.

The transparent protective film is bonded through an adhesive layer to at least one side of the polarizer. For the treatment of bonding the polarizer to the transparent protective film, an adhesive is used. Examples of the adhesive include isocyanate-based adhesives, polyvinyl alcohol-based adhesives, gelatin-based adhesives, vinyl latex-based adhesives, and water-based polyester adhesives. The adhesive is usually used as an adhesive made of an aqueous solution, and usually contains 0.5 to 60% by weight of solid. The adhesive for the bonding between the polarizer and the transparent protective film is, for example, an ultraviolet curable adhesive or electron beam curable adhesive besides the above-mentioned adhesives. The electron beam curable adhesive for polarizing films shows a favorable adhesion property to the above-mentioned various transparent protective films. A metal compound filler may be incorporated into the adhesive used in the present invention.

The pressure-sensitive adhesive layer attached polarizing film used in the present invention is a film used in the state that the pressure-sensitive adhesive layer is bonded to a transparent conductive layer containing a metal (in particular, a metal mesh) of a transparent conductive layer attached liquid crystal cell. The shape or form of the metal used in the transparent conductive layer is not particularly limited, and examples thereof include the form of a flat plate having no gaps, the form of a pattern having gaps, and a metal mesh yielded by patterning a fine line. For example, the transparent conductive layer containing the metal mesh is a layer yielded by forming a metal mesh in which a metallic fine line is formed into a lattice pattern. The corrosion resistance effect according to the present invention is remarkably produced, particularly, for a metal mesh using a highly corrosive metallic fine line.

The metal constituting the metal mesh may be any appropriate metal as far as the metal is a metal high in electroconductivity. The metal constituting the metal mesh is preferably one or more metals selected from the group consisting of gold, platinum, silver, aluminum, and copper. From the viewpoint of the electroconductivity of the mesh, aluminum, silver, copper or gold is preferred. Particularly preferred is a metal mesh having a structure containing, as a metal, aluminum since the mesh remarkably produces the corrosion resistance effect.

The transparent conductive layer containing the metal mesh may be formed by any appropriate method. The transparent conductive layer can be yielded, for example, by coating a photosensitive composition containing a silver salt (transparent-conductive-layer-forming composition) onto an adherend such as a releasing film, and then applying light-exposing treatment and developing treatment to the resultant to make the metallic fine line into a predetermined pattern. The line width and the shape of the metallic fine pattern are not particularly limited. The line width is preferably 10 μm or less. The transparent conductive layer can also be yielded by printing a paste containing fine metallic particles (transparent-conductive-layer-forming composition) into a predetermined pattern. Details of such a transparent conductive layer and a forming method thereof are described in JP-A-2012-18634. The description therein is incorporated into the present description for reference. Another example of the transparent conductive layer made of a metal mesh and a forming method thereof is a transparent conductive layer and a forming method thereof described in JP-A-2003-331654. The metal mesh may be formed by, for example, sputtering or ink-jetting, in particular preferably sputtering.

The thickness of the transparent conductive layer is preferably from about 0.01 to 10 μm, more preferably from about 0.05 to 3 μm, even more preferably from 0.1 to 1 μm.

The transparent conductive layer may have an overcoat (OC) layer (not illustrated) on the transparent conductive layer.

As the overcoat layer, an overcoat layer used ordinarily used in the present field may be used without especial limitation. The layer is a layer made of, for example, an alkyd resin, acrylic resin, epoxy resin, urethane resin or isocyanate resin. The thickness of the overcoat layer is not particularly limited, and is preferably, for example, from 0.1 to 10 μm.

### 4. Liquid Crystal Panel

It is preferred that: the liquid crystal panel of the present invention has a pressure-sensitive adhesive layer attached polarizing film including a polarizing film having a polarizer and a transparent protective film on at least one surface of the polarizer, and including the pressure-sensitive adhesive layer (made of the pressure-sensitive adhesive composition) on at least one surface of the polarizing film; and the polarizing film is bonded through the pressure-sensitive adhesive layer to a transparent conductive layer attached liquid crystal cell in which the conductive layer contains a metal mesh. Other constituents thereof are not particularly limited. In the present invention, the use of the specified pressure-sensitive adhesive layer allows to attain an improvement of the whole of the liquid crystal panel in durability, and attain others.

### 5. Image Display Device

The image display device of the present invention preferably includes the liquid crystal panel. Hereinafter, a description will be made about a liquid crystal display device as an example. However, the present invention is applicable to all display devices requiring a liquid crystal panel.

Specific examples of an image display device to which the liquid crystal panel of the present invention is applicable include a liquid crystal display device, an electroluminescence (EL) display, a plasma display panel (PD), and a field emission display (FED).

It is sufficient that the image display device of the present invention includes the liquid crystal panel of the present invention. Other constituents thereof are equivalent to those of image display devices in the prior art.

### EXAMPLES

Hereinafter, the present invention will be specifically described by way of Examples thereof. However, the invention is not limited by these Examples. In each Example, parts and percentages are all on a weight basis. Conditions for allowing any object to stand still at room temperature are wholly 23° C. and 55% RH unless otherwise specified.

### (Method for Producing Polarizing Film)

A polyvinyl alcohol film having a thickness of 80 μm was stretched 3 times between rolls different from each other in speed rate while dyed with an iodine solution having a concentration of 0.3% and a temperature of 30° C. for 1 minute. Thereafter, the film was stretched into a total stretch ratio of 6 times while immersed in an aqueous solution of 60° C. which contained boric acid in a concentration of 4% and potassium iodide in a concentration of 10% for 0.5 minutes. Next, the film was immersed in an aqueous solution of 30° C. which contained potassium iodide in a concentration of 1.5% for 10 seconds to be washed, and then the film was dried at 50° C. for 4 minutes to yield a polarizer of 20 μm thickness. Saponified triacetylcellulose films (manufactured by Konica Minolta Opto Products Co., Ltd.) each having a thickness of 40 μm were bonded, respectively, to both surfaces of the polarizer through respective polyvinyl alcohol-based adhesives to yield each polarizing film.

### Example 1

### (Preparation of Acrylic Polymer)

Into a four-necked flask equipped with stirring blade, a thermometer, a nitrogen introducing tube and a condenser was charged a monomer mixture including 80.3 parts of butyl acrylate, 16 parts of phenoxyethyl acrylate, 3 parts of N-vinylpyrrolidone, 0.3 parts of acrylic acid, and 0.4 parts of 4-hydroxybutyl acrylate. Furthermore, into 100 parts of the monomer mixture(solid content) was charged ethyl acetate together with 0.2 parts of 2,2′-azobisisobutyronitrile as a polymerization initiator. While the mixture was gently stirred, nitrogen gas was introduced into the flask to purge the inside thereof with nitrogen. Thereafter, while the liquid temperature of the inside of the flask was kept about 55° C., the polymerizable components were caused to undergo a polymerization reaction for 8 hours to prepare a solution of an acrylic polymer having a weight average molecular weight of 1,600,000.

### (Preparation of Pressure-Sensitive Adhesive Composition)

The following were blended into 100 parts of solid in the resultant acrylic polymer solution: 1 part of lithium bis(nonafluorobutanesulfonyl)imide (manufactured by Mitsubishi Materials Electronic Chemicals Co., Ltd.) as an ionic compound; 0.1 parts of an isocyanate-crosslinking agent (D160N, TAKENATE D160N, manufactured by Mitsui Chemicals, Inc.: hexamethylenediisocyanate adduct of trimethylolpropane); 0.3 parts of a peroxide crosslinking agent (BPO, NYPER BMT, manufactured by NOF Corp.: benzoyl peroxide); 0.1 parts of a silane coupling agent (X-41-1810, X-41-1810 manufactured by Shin-Etsu Chemical Co., Ltd.: a thiol group-containing silicate oligomer). In this way, a solution of an acrylic pressure-sensitive adhesive composition was prepared.

### (Production of Pressure-Sensitive Adhesive Layer Attached Polarizing Film)

Next, a fountain coater was used to coat the acrylic pressure-sensitive adhesive composition solution evenly onto a surface of a polyethylene terephthalate film treated with a silicone-based release agent (separator film). The resultant was dried at 155° C. in an air-circulating type constant-temperature oven for 2 minutes to form a pressure-sensitive adhesive layer of 20 μm thickness onto the front surface of the separator film. Next, the pressure-sensitive adhesive layer formed on the separator film was transferred onto the produced polarizing film to produce a pressure-sensitive adhesive layer attached polarizing film.

### Examples 2 to 10, and Comparative Examples 1 to 6

In each of the examples, each pressure-sensitive adhesive layer attached polarizing film was produced in the same way as in Example 1 except that changes were made from Example 1, as shown in Table 1 in the preparation of the acrylic polymer, the pressure-sensitive adhesive composition, the polarizing film, and the pressure-sensitive adhesive layer attached polarizing film. The reaction conditions, the blend amounts and others were adjusted/added to give the same heating condition, molar concentration and other conditions as in Example 1.

### <Measurement of Weight Average Molecular Weight of (Meth)Acrylic Polymer>

The weight average molecular weight (Mw) of the (meth)acrylic polymer yielded was measured by the following method.

The weight average molecular weight (Mw) of the (meth)acrylic polymer was measured by GPC (gel permeation chromatography).

Analyzer: HLC-8120GPC, manufactured by Tosoh Corp.

Columns: G7000H_{XL}+GMH_{XL}+GMH_{XL}, manufactured by Tosoh Corp.

Size of each of the columns: 7.8 mm in diameter×30 cm in length; total length: 90 cm

Column temperature: 40° C.

Flow rate: 0.8 mL/min.

Injected volume: 100 μL

Eluent: tetrahydrofuran

Detector: differential reflector (RI)

Standard sample: polystyrene

About any one of the pressure-sensitive adhesive layer attached polarizing films yielded in each of Examples and Comparative Examples, evaluations described below were made. The evaluation results are shown in Table 2.

### <Surface Resistance Value (Ω/□)>

From any one of the pressure-sensitive adhesive layer attached polarizing films yielded in each of Examples and Comparative Examples, the separator film was peeled off, and then the film was allowed to stand still under room-temperature standstill conditions for one minute. Thereafter, the surface resistance value (initial) of the pressure-sensitive adhesive layer surface was measured. Furthermore, the pressure-sensitive adhesive layer attached polarizing film was put in an environment of 60° C. temperature and 95% RH for 500 hours, and then dried at 40° C. for one hour. Thereafter, the separator film was peeled off therefrom, and then the surface resistance value (after the wet heating) of the pressure-sensitive adhesive surface was measured. The measurement was made, using a device MCP-HT450 manufactured by Mitsubishi Chemical Analytech Co., Ltd.

As the difference between the initial value and the surface resistance value after the wet heating is smaller, the uneven precipitation of the conductive agent in the pressure-sensitive adhesive is more restrained. Thus, the corrosion resistance of the pressure-sensitive adhesive layer attached polarizing film is more preferred. In Table 2, “1.0E+12” denotes a surface resistance value of 1.0×10¹² (Ω/□).

### <Transparent Conductive Layer (Metal) Corrosion Test>

Any one of the pressure-sensitive adhesive layer attached polarizing films yielded in each of Examples and Comparative Examples was cut into a piece of 15 mm×15 mm size. Therefrom, the separator film was peeled off. This was bonded onto a conductive glass piece in which an aluminum-based metallic layer of 0.1 μm thickness that was formed by sputtering was formed on a surface of a glass (non-alkali glass) piece. Thereafter, the resultant was put in an autoclave at 50° C. and 5 atm for 15 minutes. The resultant was used as a corrosion-resistance measuring sample (sample yielded by bonding the pressure-sensitive adhesive layer attached polarizing film onto the conductive glass piece corresponding to a transparent conductive layer attached liquid crystal cell). The resultant measuring sample was put in an environment of 60° C. temperature and 95% RH for 500 hours, and then the external appearance of the metallic layer was evaluated by visual observation, and through an optical microscope. About the size of a defect, the longest moiety of the defect was measured.

### (Evaluation Criterion)

⊙: The sample has no defect.

∘: The sample slightly has at a partial periphery thereof defects (the defect size: less than 0.5 mm), but has therein no defect. Thus, the sample has no practical problem.

Δ: The sample slightly has at the periphery thereof intermittent defects (the defect size: 0.5 mm or more, and less than 1 mm), but has therein no defect. Thus, the sample has no practical problem.

x: The sample slightly has at the periphery thereof continuous defects (the defect size: 1 mm or more), or has therein defects. Thus, the sample has a practical problem.

### <Durability Test (Foaming or Peeling-Off)>

Any one of the pressure-sensitive adhesive layer attached polarizing films yielded in each of Examples and Comparative Examples was cut into a piece of 15 inch size. From this sample, the separator film was peeled off and a laminator was used to bond the resultant onto a non-alkali glass piece (EG-XG, manufactured by Corning Inc.) of 0.7 mm thickness. Next, the resultant was subjected to autoclave treatment at 50° C. and 0.5 MPa for 15 minutes to bond the sample completely on the non-alkali glass piece. The sample subjected to this treatment was treated in an atmosphere of 60° C. temperature and 95% RH for 500 hours (humidifying test). The external appearance between the polarizing film and the glass piece was evaluated by visual observation in accordance with the following criterion.

### (Evaluation Criterion)

⊙: The sample never has any external appearance change such as foaming or peeling-off.

∘: The sample has at an end thereof slight peeling-off, or foaming, but has no practical problem.

Δ: The sample has at an end thereof peeling-off, or foaming, but has no practical problem unless the sample is used for an especial article.

x: The sample has at an end thereof remarkable peeling-off to have a practical problem.

TABLE 1

| | | | | | Ionic compound | | | |
|---|---|---|---|---|---|---|---|---|
| Blend | | Molecular | Crosslinking | | (conductive agent) | | Silane coupling | |
| components | | weight (Mw) | agent | | | Carbon | agent | |
| (parts by | | of obtained | Isocyanate | Peroxide | | atom number | X-41- | KBM |
| weight) | Polymer composition | polymer | D160N | BPO | Species | in anion | 1810 | 403 |
| Example 1 | BA/PEA/NVP/AA/HBA = 80.3/16/3/0.3/0.4 | 1,600,000 | 0.1 | 0.3 | Li-NFSI | 8 | 0.1 | |
| Example 2 | BA/PEA/NVP/AA/HBA = 80.3/16/3/0.3/0.4 | 1,600,000 | 0.1 | 0.3 | Li-HFSI | 6 | 0.1 | |
| Example 3 | BA/PEA/NVP/AA/HBA = 80.3/16/3/0.3/0.4 | 1,600,000 | 0.1 | 0.3 | Li-PFSI | 4 | 0.1 | |
| Example 4 | BA/PEA/NVP/AA/HBA = 80.3/16/3/0.3/0.4 | 1,600,000 | 0.1 | 0.3 | MTOA-NFSI | 8 | 0.1 | |
| Example 5 | BA/PEA/NVP/AA/HBA = 80.3/16/3/0.3/0.4 | 1,600,000 | 0.1 | 0.3 | BMI-NFSI | 8 | 0.1 | |
| Example 6 | BA/PEA/NVP/AA/HBA = 76.3/16/0.7/0.3/0.4 | 1,600,000 | 0.1 | 0.3 | Li-NFSI | 8 | 0.1 | |
| Example 7 | BA/PEA/NVP/AA/HBA = 68.3/16/15/0.3/0.4 | 1,500,000 | 0.1 | 0.3 | Li-NFSI | 8 | 0.1 | |
| Example 8 | BA/PEA/NVP/AA/HBA = 63.3/16/20/0.3/0.4 | 1,450,000 | 0.1 | 0.3 | Li-NFSI | 8 | 0.1 | |
| Example 9 | BA/PEA/DMAEA/AA/HBA = 80.3/16/3/0.3/0.4 | 1,600,000 | 0.1 | 0.3 | Li-NFSI | 8 | 0.1 | |
| Example 10 | BA/PEA/NVP/HBA = 80.6/16/3/0.4 | 1,550,000 | 0.1 | 0.3 | Li-NFSI | 8 | 0.1 | |
| Comparative | BA/PEA/NVP/AA/HBA = 82.8/16/0.5/0.3/0.4 | 1,600,000 | 0.1 | 0.3 | Li-TFSI | 2 | 0.1 | |
| Example 1 | | | | | | | | |
| Comparative | BA/AA/HBA = 99.3/0.3/0.4 | 1,500,000 | 0.1 | 0.3 | Li-TFSI | 2 | | 0.2 |
| Example 2 | | | | | | | | |
| Comparative | BA/AA/HBA = 99.3/0.3/0.4 | 1,500,000 | 0.1 | 0.3 | Li-CTFSI | 3 | | 0.2 |
| Example 3 | | | | | | | | |
| Comparative | BA/PEA/NVP/AA/HBA = 80.3/16/3/0.3/0.4 | 1,600,000 | 0.1 | 0.3 | Li-CTFSI | 3 | 0.1 | |
| Example 4 | | | | | | | | |
| Comparative | BA/PEA/NVP/AA/HBA = 80.3/16/3/0.3/0.4 | 1,600,000 | 0.1 | 0.3 | EMI-FSI | 0 | 0.1 | |
| Example 5 | | | | | | | | |
| Comparative | BA/PEA/NVP/AA/HBA = 80.3/16/3/0.3/0.4 | 1,600,000 | 0.1 | 0.3 | 4MOPy-FSI | 0 | 0.1 | |
| Example 6 | | | | | | | | |

In Table 1, abbreviates are as follows:

### <Monomer Components>

BA: butyl acrylate

PEA: phenoxyethyl acrylate

NVP: N-vinyl-pyrrolidone

DMAEA: N,N-dimethylaminoethyl acrylate

AA:acrylic acid

HBA: 4-hydroxybutyl acrylate

### <Crosslinking Agents>

D160N: isocyanate-crosslinking agent, TAKENATE D160N (hexamethylenediisocyanate adduct of trimethylolpropane) manufactured by Mitsui Chemicals, Inc.

BPO: peroxide-crosslinking agent, benzoyl peroxide (NYPER BMT, manufactured by NOF Corp.)

### <Ionic Compounds (Conductive Agents)>

Li-NFSI: lithium bis(nonafluorobutanesulfonyl)imide (manufactured by Mitsubishi Materials Electronic Chemicals Co., Ltd.)

Li-HFSI: lithium bis(heptafluoropropanesulfonyl)imide (manufactured by Wako Pure Chemical Industries, Ltd.)

Li-PFSI: lithium bis(pentafluoroethanesulfonyl)imide (manufactured by Tokyo Chemical Industry Co., Ltd.)

MTOA-NFSI: methyltrioctylammonium bis(nonafluorobutranesulfonyl)imide (manufactured by Mitsubishi Materials Electronic Chemicals Co., Ltd.)

BMI-NFSI: butylmethylimidazolium bis(nonafluorobutanesulfonyl)imide (manufactured by Mitsubishi Materials Electronic Chemicals Co., Ltd.)

Li-TFSI: lithium bis(trifluoromethanesulfonyl)imide (manufactured by Mitsubishi Materials Electronic Chemicals Co., Ltd.)

Li-CTFSI: lithium N,N-hexafluoropropane-1,3-disulfonylimide (manufactured by Mitsubishi Materials Electronic Chemicals Co., Ltd.)

EMI-FSI:1-ethyl-3-methylimidazolium bis(fluorosulfonyl)imide (manufactured by Dai-ichi Kogyo Seiyaku Co., Ltd.)

4MOPy-FSI:1-octyl-4-methylpyridinium bis(fluorosulfonyl)imide (manufactured by Dai-ichi Kogyo Seiyaku Co., Ltd.)

### <Silane Coupling Agents>

X-41-1810: thiol group-containing silicate oligomer (manufactured by Shin-Etsu Chemical Co., Ltd.), and

KBM403: epoxy group-containing silane coupling agent (manufactured by Shin-Etsu Chemical Co., Ltd.)

TABLE 2

| | | | | Durability test |
|---|---|---|---|---|
| | Surface resistance | | | (foaming and |
| | value (Ω/□) | | | peeling-off) |
| | | After 500 hours | | After 500 hours |
| Evaluation | | at 60° C. | Metal | at 60° C. |
| results | at initial | and 95% RH | corrosion | and 95% RH |
| Example 1 | 4.1E+11 | 4.2E+11 | ⊙ | ⊙ |
| Example 2 | 3.5E+11 | 3.7E+10 | ⊙ | ⊙ |
| Example 3 | 2.7E+11 | 2.9E+11 | ◯ | ⊙ |
| Example 4 | 7.6E+11 | 7.9E+11 | ⊙ | ◯ |
| Example 5 | 4.3E+11 | 4.4E+11 | ⊙ | ◯ |
| Example 6 | 4.5E+11 | 4.9E+11 | ◯ | ⊙ |
| Example 7 | 8.8E+11 | 8.9E+11 | ⊙ | ◯ |
| Example 8 | 1.0E+12 | 1.1E+12 | ⊙ | Δ |
| Example 9 | 4.4E+11 | 4.9E+11 | ◯ | ◯ |
| Example 10 | 4.2E+11 | 4.4E+11 | ⊙ | ⊙ |
| Comparative | 1.8E+11 | 1.9E+11 | X | ⊙ |
| Example 1 | | | | |
| Comparative | 3.7E+11 | 4.7E+11 | Δ | Peeling-off X |
| Example 2 | | | | |
| Comparative | 4.6E+11 | 5.4E+11 | Δ | Peeling-off X |
| Example 3 | | | | |
| Comparative | 4.3E+11 | 4.4E+11 | X | Δ |
| Example 4 | | | | |
| Comparative | 2.9E+11 | 3.1E+11 | X | Δ |
| Example 5 | | | | |
| Comparative | 4.5E+11 | 4.8E+11 | X | Δ |
| Example 6 | | | | |

It has been verified from the evaluation results in Table 2 that: all Examples make use of a pressure-sensitive adhesive layer attached polarizing film having a pressure-sensitive adhesive layer yielded using a (meth)acrylic polymer containing a specified monomer in a desired proportion, and using an ionic compound containing a specified anionic component; thus, the pressure-sensitive adhesive layer attached polarizing films are not raised in surface resistance and satisfy a stable antistatic performance, and is excellent in corrosion resistance and durability even in a wet heat environment. In the meantime, it has been verified that: all Comparative Examples make use of a pressure-sensitive adhesive layer attached polarizing film having a pressure-sensitive adhesive layer yielded by using a (meth)acrylic polymer containing a specified monomer in an undesired proportion, and using an ionic compound containing no specified ionic compound; thus, Comparative Examples are poorer in corrosion resistance and durability as compared with Examples. In particular, Comparative Examples 2 and 3 never contain any nitrogen-containing monomer; thus, the pressure-sensitive adhesive layer attached polarizing films are more largely raised in surface resistance value, after the wet heating, from the initial surface resistance value thereof, so as to gain a stable antistatic performance.

### DESCRIPTION OF REFERENCE SIGNS

1 Polarizing film
2 Pressure-sensitive adhesive Layers
3 Pressure-sensitive adhesive layer-attached polarizing Film
4 Transparent conductive layer containing a metal mesh
5 Glass substrate
6 Liquid crystal layer
7 Driving electrode
8 Pressure-sensitive adhesive Layer
9 Polarizing film
10 Driving-electrode-concurrently-functioning sensor layer
11 Sensor Layer

1. A pressure-sensitive adhesive composition, comprising: a (meth)acrylic polymer; and an ionic compound having an anionic component and a cationic component,
wherein the (meth)acrylic polymer comprises 0.6% or more by weight of a nitrogen-containing monomer as a monomer unit,
a total number of carbon atoms in the anionic component is 4 or more, and
the anionic component is represented by at least one selected from the following general formula (1)
(CₙF₂ₙ₊₁SO₂)₂N⁻ (1)
wherein n is an integer from 2 to 10, and the following general formula (2):
CF₂(CₘF₂ₘSO₂)₂N⁻ (2)
wherein m is an integer from 2 to 10.

2. The pressure-sensitive adhesive composition according to claim 1, comprising a crosslinking agent, wherein the crosslinking agent comprises an isocyanate-crosslinking agent, and/or a peroxide-crosslinking agent.

3. A pressure-sensitive adhesive layer, which is formed from the pressure-sensitive adhesive composition according to claim 1.

4. A pressure-sensitive adhesive layer attached polarizing film, comprising a polarizing film comprising a polarizer and a transparent protective film provided on at least one surface of the polarizer; and the pressure-sensitive adhesive layer according to claim 3 on at least one surface of the polarizing film.

5. A liquid crystal panel, comprising the pressure-sensitive adhesive layer attached polarizing film according to claim 4; and the polarizing film being bonded through the pressure-sensitive adhesive layer to a transparent-conductive-layer attached liquid crystal cell comprising a metal mesh.

6. An image display device, comprising the liquid crystal panel according to claim 5.
